(19) United States
(12) Patent Application Publication
(10) Pub. No.: US 2016/0214005 A1
(43) Pub. Date: Jul. 28, 2016

(54) Timeline Game

(71) Applicant: Barry W. McClure, Huntsville, AL (US)

(72) Inventor: Barry W. McClure, Huntsville, AL (US)

(21) Appl. No.: 15/005,838

(22) Filed: Jan. 25, 2016

Related U.S. Application Data
(60) Provisional application No. 62/107,892, filed on Jan. 26, 2015.

(51) Int. Cl. A63F 3/04; A63F 13/44; A63F 13/23

(52) U.S. Cl. CPC A63F 3/0449; A63F 13/23; A63F 13/44

(57) ABSTRACT

The present invention relates to a game that can be played on a game board or played as an application on a smart phone, electronic notebook, personal computer, or other electronic device. Each player is asked to order from earliest to latest for times presented from a category. Upon the successful ordering of each of the four items, a player advances along the game board towards the finish line. If a player fails to correctly order each of the four items, then said player moves sideways along the game board. The application allows multiple players in varying locations to play the game together.

### CROSS-REFERENCE TO RELATED APPLICATIONS

This application claims the benefit of the priority to provisional application No. 62/107,892 titled “Timeline” filed with the United States Patent and Trademark Office on Jan. 26, 2015, the disclosure of which is incorporated herein by reference as if fully set forth herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### INCORPORATION-BY-REFERENCE OF MATERIALS SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR JOINT INVENTOR

The inventor did not disclosed the invention herein prior to the 12 month period preceding the filing of his provisional application.

### BACKGROUND OF THE INVENTION

1. Field of the Invention

The present invention relates generally to games of chance and skill and consists of a board game where playing pieces are movable over the stations along defined paths of travel. The game encompasses cards that are keyed to certain stations. The cards ask questions relating to identifying the correct timeline for the occurrence of certain events. This game may also be played on a smart phone, electronic notebook, readers, personal computer and other electronic devices as an application or installed game. This game can be used for both recreation and as an educational tool. Additionally, this game may be adapted for use as a television game show.

2. Description of Related Art

The invention herein relates generally to board games and game systems and methods for electronic games. Numerous board games and electronic games have been disclosed in the prior art that are adapted to provide entertainment or to provide learning instruction, such as questions and answers on various subject matters or skill and chance that enhances enjoyment of the game. Hausman (U.S. Pat. No. 4,029,320) discloses a board game with playing pieces movable over stations along defined paths of travel. Hausman discloses moving game pieces based on throwing of dice and answering questions related to reading or other educational subjects that are listed on tutorial cards (U.S. Pat. No. 4,029,320). Montijo (U.S. Pat. No. 4,640,315) discloses an educational game played on a game board with play game chips wherein players take turns trying to spell, pronounce and define words correctly. Montijo utilizes play money to reward players (U.S. Pat. No. 4,640,315). Wyk (WO 2002074401 A1) discloses a geographic board game where players respond to questions relating to geographical regions and are scored accordingly. Stanley (WO 2008007172 A1) discloses a test preparation device that may be used with a game board including problem cards. Players are students that are asked to answer questions relating to an upcoming examination they are to take such as the SAT (Scholastic Aptitude Test) or the attorney bar admissions examination (WO 2008007172 A1).

A number of inventions relating to electronic games have been disclosed in the prior art. Chan (U.S. Pat. No. 5,088,928 A) discloses the utilization of both a computer touch pad and joy stick in adapting a board game to play on a computer system. Freimuth (US 2014/0356838 A1) discloses an electronic educational game wherein test questions are displayed on a monitor and the user is to drag the answer options from the test problem to answer receiving location to improve the player's test taking skills to improve their scores on standardized exams. Similarly, Freimuth (US 20130323692 A1) discloses an educational game system that displays key words and distractor words simultaneously on an electronic device such as a smart phone such that a student can practice identifying and applying key words in standardized examinations.

The present invention differs from the prior art in that it provides game cards with questions relating to the timeline in which events, people, places and incidents occurred throughout history. The board game of this present invention provides entertainment and learning for groups of players and can be played with a minimum of two players and a maximum of seven individual players. The electronic version of this invention allows individuals and groups to play against each other and themselves. This invention improves knowledge relating to the time that events in the following areas occurred: (1) events, disasters, (2) famous people, (3) inventions, discoveries, (4) structures, monuments, places, (5) leaders, rulers, (6) art, entertainment, sports, and (7) Americana. These categories can be altered to test and improve the knowledge of the timeline of events in many other categories. Nothing in the prior art discloses a game that tests the timeline of events.

### BRIEF DESCRIPTION OF THE SEVERAL VIEWS OF THE DRAWINGS

FIG. 1 illustrates a top view of one embodiment of the Timeline Game playing board.

FIG. 2 illustrates a front view of a sample question of one embodiment of a game card for the Timeline Game.

FIG. 3 illustrates an exterior view of a sample question of one embodiment of a game card for the Timeline Game.

FIGS. 4, 5, 6, and 7 depict embodiments of a player's game piece for the Timeline Game.

FIG. 8 depicts a schematic of an electronic application to play the Timeline Game on an electronic device such as a smart phone, electronic notebook, or personal computer.

FIG. 9 is a flow chart depicting one embodiment of the login process for the electronic application.

FIG. 10 is a flow chart depicting one embodiment of a process to create a new user account.

FIG. 11 is a flow chart depicting one embodiment of the process for a user that has forgotten his or her password.

FIG. 12 is a flow chart illustrating one embodiment of the process for a user to exit the Timeline Game electronic application.

FIG. 13 is a flow chart illustrating one embodiment of the process to invite other players to join a game.

FIG. 14 is a flow chart illustrating one embodiment of the process for a user to join a game following an invitation from another user.

FIG. 15 is a flow chart depicting the process of playing the Timeline Game electronic application.

FIG. 16 depicts a screenshot that may be seen when a user signs onto the Timeline Game electronic application.

FIG. 17 depicts a screenshot that may be seen when a user is prompted to select the number of players that will be playing the Timeline Game electronic application.

FIG. 18 depicts a screenshot that may be seen when a user is prompted by the electronic application to select a game piece that will mark his or her location on the Timeline Game game board.

FIG. 19 illustrates a screenshot that may be seen when a user is selecting his or her starting position on the Timeline Game game board.

FIG. 20 illustrates a screenshot that may be seen when a user and another player have selected their starting positions on the game board of the Timeline Game electronic application.

FIG. 21 depicts a screenshot that may be seen when a user is prompted by the electronic application to place in the correct order a series of events.

FIG. 22 depicts a screenshot that may be seen when a user selects the camera function on the screenshot depicted in FIG. 21.

FIG. 23 depicts a screenshot that may be seen when the electronic application displays the correct order of events for the series of events prompted in FIG. 21.

FIG. 24 illustrates the movement of a player's game piece upon said player correctly ordering the series of events prompted in FIG. 21.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, et., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an, embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified embodiment. Likewise, the disclosure is not limited to various embodiments given in this specification.

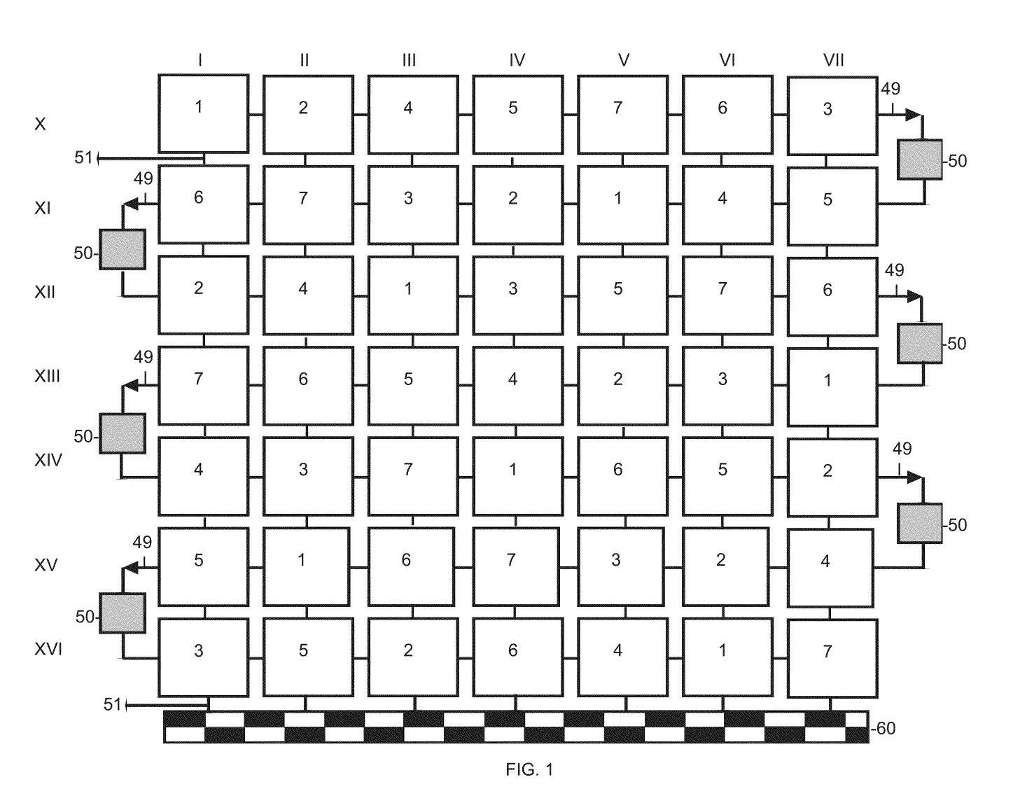

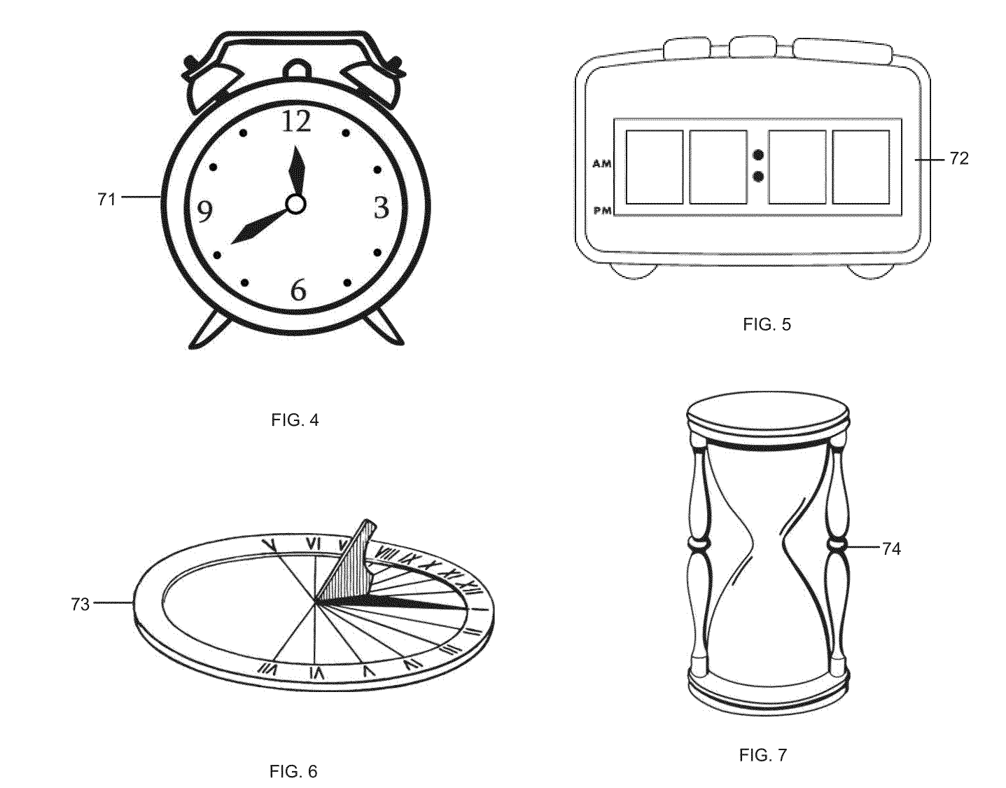

Unless otherwise defined, all technical and scientific terms used herein have the same meaning as commonly understood by one of ordinary skill in the art to which this disclosure pertains. In the case of conflict, the present document, including definitions will control. The present invention comprises, in one form thereof, a board game wherein players advance and win based on their ability to place the time that events occurred from earliest to latest. FIG. 1 depicts the game board. The game board contains seven rows of boxes—Rows X, XI, XII XIII XIV, XV, and XVI—with each row containing seven boxes, for a total of 49 boxes. These 49 boxes may also be divided into 7 columns—Columns I, III, IV, V, VI, and VII—with each column including 7 boxes. Each player of the game is represented by a game piece (FIGS. 4 through 7), wherein said game piece is positioned on one of the 49 boxes during game play. The game board also contains six small boxes 50, and a checkboard 60 at the bottom of the game board. Each of the forty-nine boxes is numbered 1 through 7. Each of these numbers represents a question category that test the timeline of events occurring in (1) events and disasters, (2) famous people, (3) inventions and discoveries, (4) structures, monuments, and places, (5) leaders and rulers, (6) art, entertainment, and sports, and (7) Americana. Each of these seven categories has a color to identify the category of the question asked on the correspondingly colored playing card. Boxes numbered with a 1 on FIG. 1 are marked with the color red on their exterior and ask questions relating to the category of the timeline in which events and disasters occurred. FIG. 1 boxes numbered 2, are marked with the color orange and correspond to cards that ask questions relating to the category of the timeline in which famous people lived. Boxes numbered 3 on FIG. 1 are marked the color yellow and correspond to cards that ask questions relating to the category of the timeline in which inventions and discoveries occurred. FIG. 1 boxes numbered 4 are marked with the color green and correspond to cards that ask questions relating to the timeline for structures, monuments, and places. Boxes numbered 5 on FIG. 1 are marked with the color blue and correspond to cards that ask questions relating to the timeline for leaders and rulers. FIG. 1 boxes numbered 6 are marked with the color purple and correspond to cards that ask questions relating to the timeline for art, entertainment, and sports. Boxes on the game board numbered 7 on FIG. 1 are marked with the color crimson and correspond to cards that ask questions relating to the timeline for Americana events.

Each row of FIG. 1 contains seven boxes with each box containing a different number/color so that no number/color of box is repeated in any row. Additionally, each column of FIG. 1 contains seven boxes with each box containing a different number/color so that no number/color is repeated in any column.

Boxes number 50 on FIG. 1 are timeout boxes. When a team/player lands on any of the six boxes numbered 50, he or she loses a turn. Once any team/player loses a turn due to being positioned in a box numbered 50, they must place the events in the correct timeline for a card with an exterior color corresponding to the color of the first box following the movement of their playing piece/token as evidenced by the arrows on the game board FIG. 1. The checkerboard area 60 is the winner's area. Once a team or player's playing piece/token reaches box 60 before any of the other teams or players playing Timeline, they have won the game.

Line 49 include an arrow to reflect the travel of a player's game piece during game play. Line 49 starts at the box Row X, Column I and travels toward column VII along Row X. Line 49 then travels from Row X, Column I through Box 50 to the box positioned at Row XI, Column VII. Next, 49 runs along Row XI until it reaches Row XI, Column I. Line 49 runs through Box 50 to box Row XI, Column I. Line 49 runs along Row XII, Column I to Column VII, and through Box 50, to Row XIII, Column VII. Line 49 runs along Row XIII through Column I, runs through Box 50 to Row XIV, Column I. Line 49 runs the length of Row XIV, through Column VII, through Box 50, and through Row XV. Next, Line 49 runs the length of Row XV, through Column I, through Box 50, to Row XVI at Column I. Finally, Line 49 runs from Column I to Column VII along Row XVI. Players travel along Line 51, which runs from each box positioned on Row XVI to Checkerboard 60, to the winning position checkerboard 60.

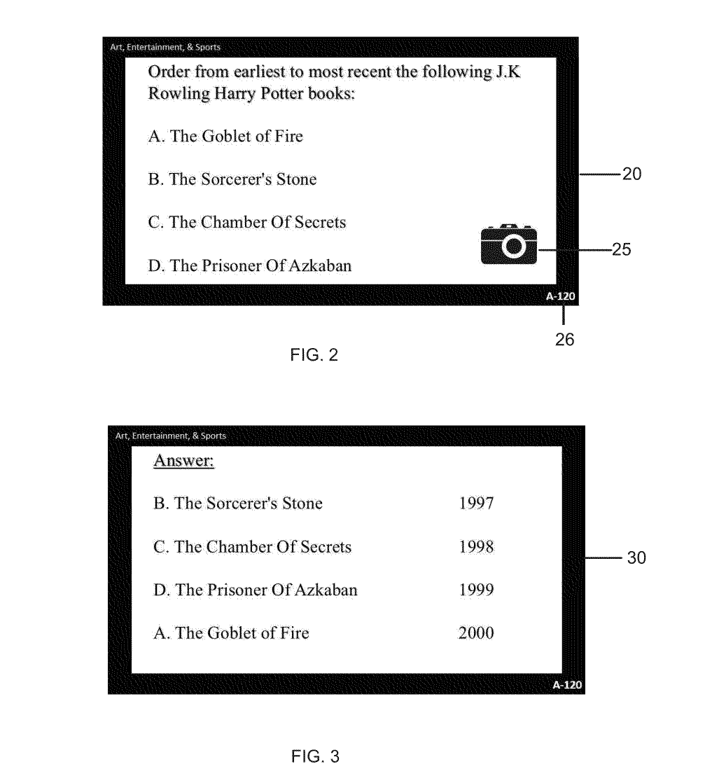

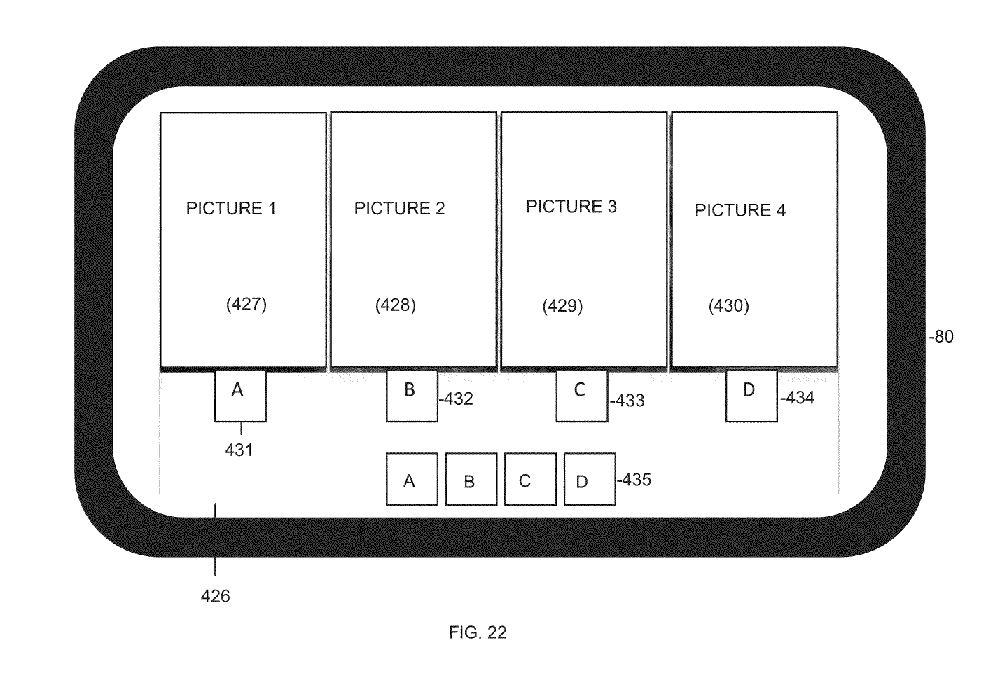

FIG. 2 and FIG. 3 show a front 20 and exterior view 30 of a game card, respectively. The front face 20 of FIG. 2 game card is colored along its outer perimeter to correspond to one of the seven category colors as set forth above. Additionally, the front of game card 20 may lists four different items, labeled A, B, C, and D, that the player positioned on the relevant box is asked to order from the earliest in time to the latest in time. The front face 20 of the electronic game card may also include a symbol for a camera 25. If a player clicks on camera 25, illustrations for each of the four items labeled A, B, C, and D are shown (FIG. 22). The front face 20 and exterior face 30 of the game cards may include a number 26 that is associated with each game card. The exterior face 30 of each game card may list the correct ordering of the four different items labeled A, B, C, and D with the earliest item being listed first at the top of exterior face 30 and the latest item being listed at the bottom of exterior face 30. An alternate embodiment of the present invention contains cards with four questions on each side and corresponding answers to each of the four questions on the opposite side of each card so that each card contains four questions and four answers on each side. Cards containing questions relating to the timeline that events and disasters occurred are marked on the exterior with the color red, which corresponds to the red color seen on that game board boxes numbered 1 (See FIG. 1). Cards containing questions relating to the timeline to famous peopled are marked on the exterior with the color orange that FIG. 1 boxes numbered 2 are marked. Cards containing questions relating to the timeline of inventions and discoveries are marked the color yellow on the exterior which corresponds to the color marked on boxes numbered with a 3 on FIG. 1. Cards containing questions relating to the timeline of structures, monuments, and places are marked on the exterior with the color green so that the color of these cards match the color of boxes on FIG. 1 numbered 4. Cards containing questions relating to the timeline of leaders and rulers are marked blue on the exterior so that they match the color of boxes numbered 5 on FIG. 1. Cards containing questions relating to the timeline of art, entertainment, and sports occurred are marked purple on the exterior so that they correspond to FIG. 1 boxes numbered 6. The exterior of cards containing questions relating to the timeline of Americana (questions relating to America) are marked with the color crimson to match FIG. 1 boxes numbered 7.

FIGS. 4, 5, 6, and 7 depict a few examples of game pieces that may be utilized in the Timeline Game. Each of the game pieces shown: windup alarm clock 71, electric or battery-powered alarm clock 72, sun dial 73, and hour glass 74, is an object that displays time. Playing pieces/tokens may be produced of any suitable material and may consist of any suitable size. Numerous possible playing piece designs may be used.

This invention is played in the following manner. Teams of players or individual players choose a playing piece or token and place it on any block in the top row of FIG. 1. The first team/player to reach the bottom row of FIG. 1 wins the Timeline Game. The teams of players or players choose who will start first by adopting a method such as “oldest first” or “youngest first”, and then proceed in a clockwise manner around the game board in the order that teams of players or players are seated/situated around the game board.

Each team or player gets one question per turn, unless they are on a box numbered 50 and have lost a turn. Each turn consist of a team/player drawing a card from the stack with the exterior color FIG. 3 matching the color of the box that they have their playing piece/token positioned on. If the team/player is able to place the series of occurrences on the front face of the card 20 in the correct timeline, then the team/player advances in a straight line one box closer toward the checkerboard area 60. If a team/player is not able to correctly place the series of questions/occurrences on the front face 20 of the game question card (FIG. 2), then said team/player moves his or her playing piece/token sideways in the direction marked on the game board FIG. 1. If the next block is numbered 50, the player experiences a time out at the next turn. If the box landed on following an incorrect answer is not numbered 50, then the team/player will not lose their/his turn. Instead, said team/player will at the next play draw a playing card with an exterior color that matches the color of the box the team's/player's playing piece is positioned on. In order to reach the checkerboard area 60 from a box numbered 50, the team/player must answer a question from the deck of cards of their choosing correctly. The game continues until this occurs or until another team/player reaches the checkerboard area first.

Teams/players may vary the game by offering a number of agreed upon clues, providing the date of one event listed on the playing card FIG. 2, providing the position of one event within the series of events listed on the playing card, or providing both the date and position of one event listed on the playing card face 20 of FIG. 2.

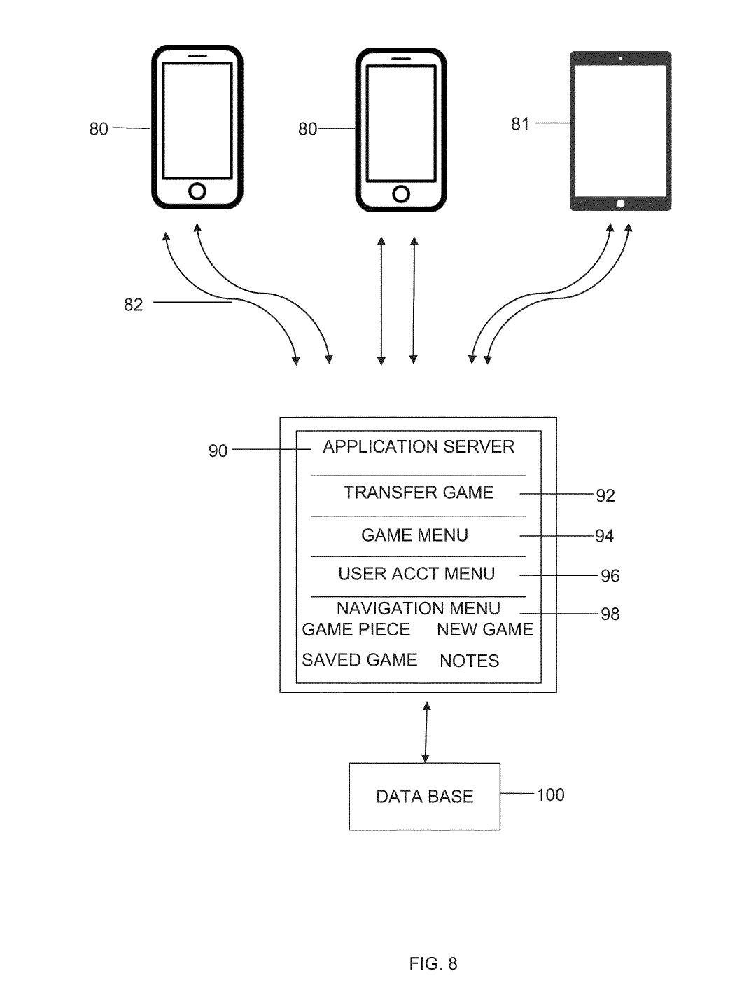

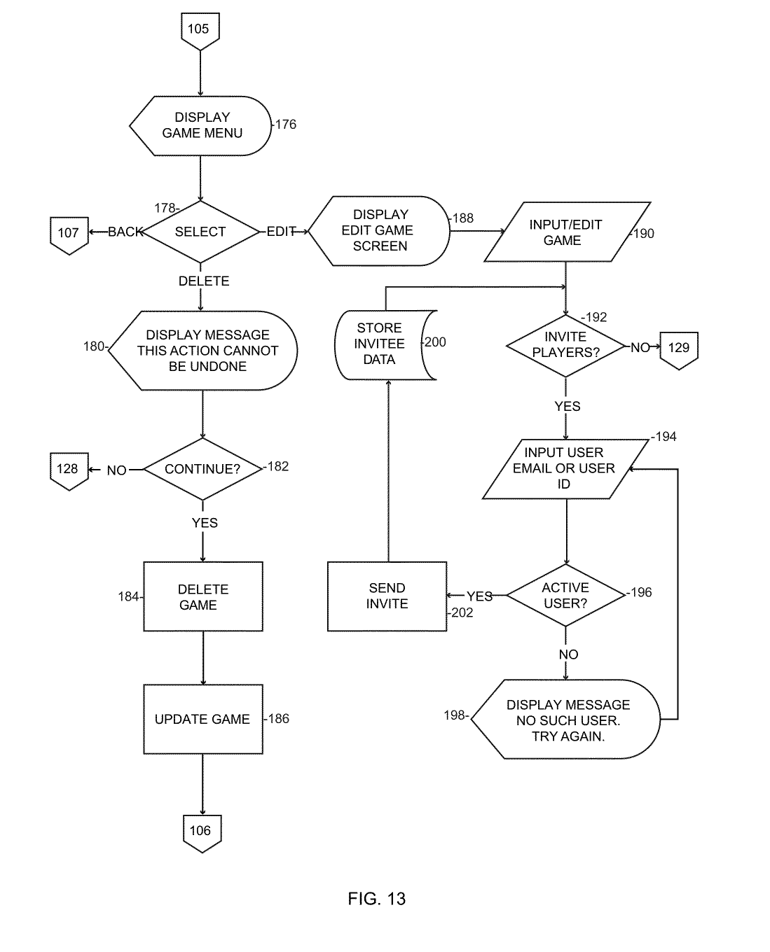

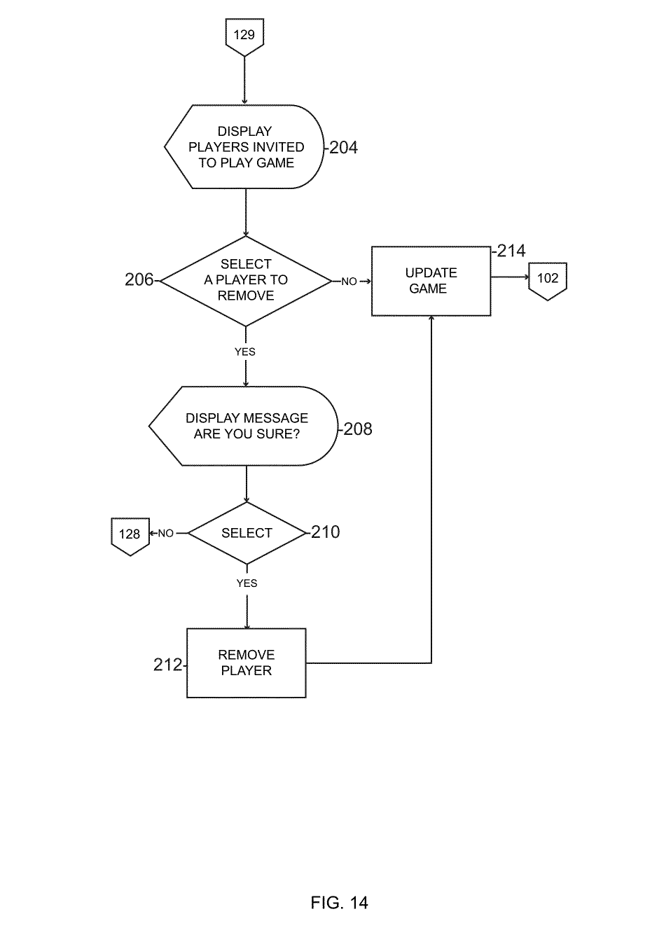

FIGS. 8 through 24 depict the electronic application of the Timeline Game. The Timeline Game application is played in a fashion similar to the board game, set forth above. The electronic application automatically generates the game board as a screenshot, generates electronic tokens/game pieces, and generates questions based on the numbered box the playing piece/token was positioned on. Additionally, the electronic version would guide the player(s) along the boxes in the same manner as the game board. The electronic version would maintain the time that it takes for each player to complete the game and compare that time to the time(s) it takes others to complete the game.

With reference to the figures, FIG. 8 depicts a pictorial representation of an exemplary distributed data processing system in which aspects of the illustrative embodiments may be implemented. The distributed data processing system may include a network of computers in which embodiments of the illustrative embodiments may be implemented. The distributed data processing system contains at least one network 82, which is the medium used to provide communication links between various devices and computers connected together within the distributed data processing system. Network 82 may include connections, such as wire, wireless, communication links, or fiber optic cables.

In distributed data processing system of FIG. 8, server 90 is connected to a network 82 along with data base 100, which is utilized for storage Players are connect to the network through their electronic device 80. Electronic devices may include a personal computer, an electronic notebook 81, a mobile phone or smart phone 80, a laptop computer, the Internet, or a proprietary website. In the depicted example, server 90 may provide data, such as boot files, operating system images, and applications to the electronic device 80 and 81. In this instance, electronic devices 80 and 81 are clients to server 90 in the depicted example. The distributed data processing system may include additional servers, game clients, and other devices not shown.

More particularly, server 90 may provide a server for maintaining the electronic notebooks of players. Server 90 allows the player to transfer between games 92, access the “Game Menu” 94, access “User Account Menu” 96, and to Navigate 98 between application functions. The server 90 may run Timeline Game notebook application software and maintain a database 100 for storage of personal data, game content, and electronic notebook Web pages for all players.

Electronic devices 80 and/or 81 may run Timeline Game notebook software that a player uses to interact with the electronic device. The player is considered online when the player is logged into the game server 100 through an electronic device 80 and/or 81. Whenever a player enters personal data or game content while using the Timeline Game application, the application automatically transforms the data into a Web page(s) and updates their Web page(s)

In one embodiment, the server 100 may run a Web server application, which provides Web-based user interfaces for reading or composing player invitations and transferring player data and game content.

The example depicted in FIG. 8, the distributed data processing system is the Internet with an electronic network representing a worldwide collection of networks and gateways that use the Transmission Control Protocol (TCP/IP) suite of protocols to communicate with one another. The distributed data processing system may be implemented to include a number of different networks, such as an intranet, local area network (LAN), a wide area network (WAN), or the like.

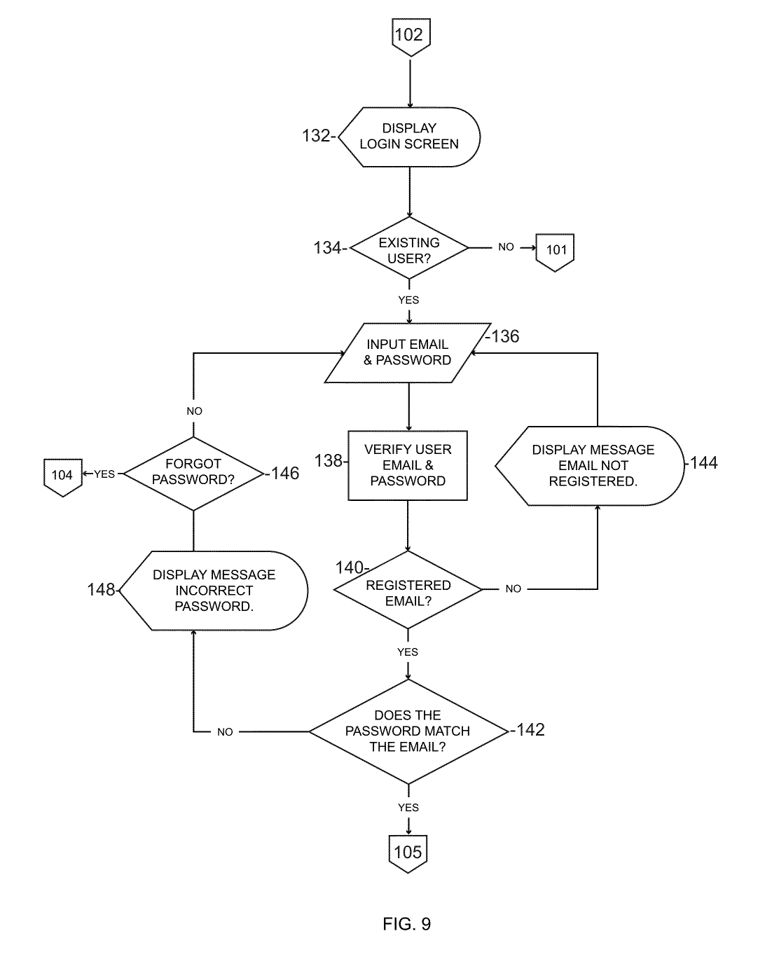

FIG. 9 is a flow chart illustrating the log in process. When the user starts the application at Box 102, the log in screen will be displayed, Box 132, on the screen of the electronic device. Upon confirmation that an existing user is attempting to log on at Box 134, the user will input their email and password information at Box 136. If a new user attempts to log on at Box 134, then the application will initiate the process of creating new user information, Box 101. Once the email and password information have been verified by the user at Box 136, the application will inquire whether the email address is a registered email at Box 140. If the email is verified at Box 140, then the application will confirm that the password provided by the user matches the stored password at Box 142. If the password entered by the user matches the stored password, the application will proceed to Box 105 to the “Game Menu” 94. If the registered email address cannot be verified at Box 140, then the application will display on the screen of the electronic device that the email is not registered, Box 144. If the password cannot be verified at Box 42, then the application will display a message to inform the user that an incorrect password has been entered, Box 148. The application will then prompt the user to confirm whether the password has been forgotten at Box 146. If the password has been forgotten by the user, the application will send the password to the email account of the user at Box 104.

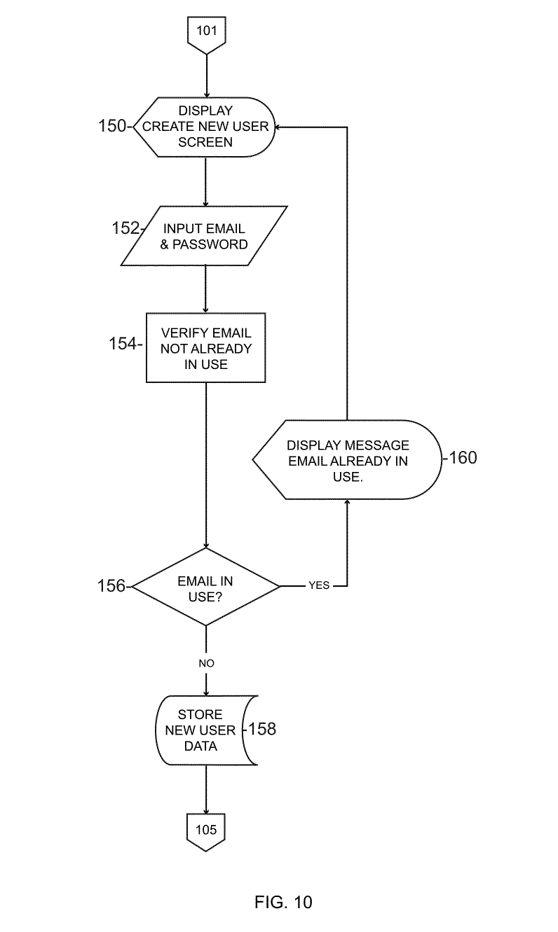

FIG. 10 is a flow chart depicting the process that the application utilizes to create a new user account beginning at Box 101. The application displays a message to the user to create a new user account at Box 150. The user then inputs their email and password information at Box 152, and the application verifies that the email entered is not currently in use by another at Box 154. If the email is not in use at Box 156, the application will store the new user data at Box 158 and proceed to Box 105 and display the “Game Menu” screen 94. If the email is currently in use at Box 156, the application will display a message on the electronic device to indicate that the email is already in use at Box 160, and the application will proceed to display a message to create a new screen user account, Box 150.

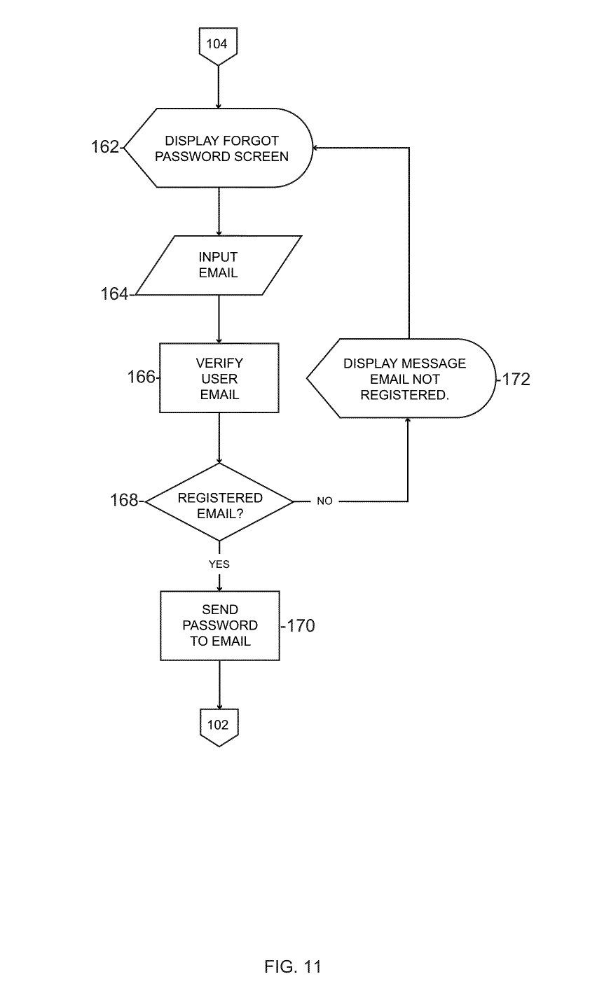

The process the application utilizes to send a forgotten password to the user is depicted in FIG. 11. If the user has forgotten their password at Box 104, then the application will display a message indicating that the password has been forgotten at Box 162. Next, the user is prompted to enter their email address at Box 164 so that the application can verify the email, Box 166. If the email is registered with the application at Box 168, the password will be sent to the email account listed for the user, Box 170, and the application will proceed from Box 102 to display the Log In” screen at Box 132. If the email is not registered with the application, then a message to indicate that the email is not registered will be displayed, Box 172, and the application will display a message prompting the user that he or she has forgotten their password at Box 162.

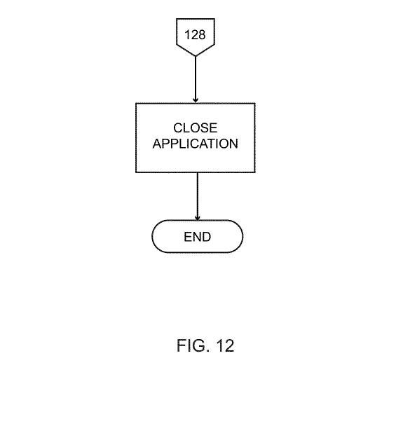

FIG. 12 is a flow chart depicting the process of closing the Timeline Game Application. When the user decides to close the application, Box 128, the application proceeds through the close application process at Box 172, and shuts down the application while saving all changes made, Box 174. The application can be closed at multiple points during the application.

Because the user of this application may be involved in several Timeline Games during the same time period or a user may simply want to save a completed game, the application allows for the creation and storage of more than one game that may be accessed via the “Navigation Menu” 98. The “Navigation Menu” 98 may be programmed to allow a user to select tokens/game pieces for a particular game, to start a new game at any time, including while a player is currently playing another Timeline Game, save a game to return to playing at a later time, or to post notes and comments about a particular game, game pieces, other players, etc. The Timeline Game Application may be programmed to allow a user to transfer game information 92 such as name of players, game pieces employed, time of completion of game, # incorrect and correct answers, or any other relevant data.

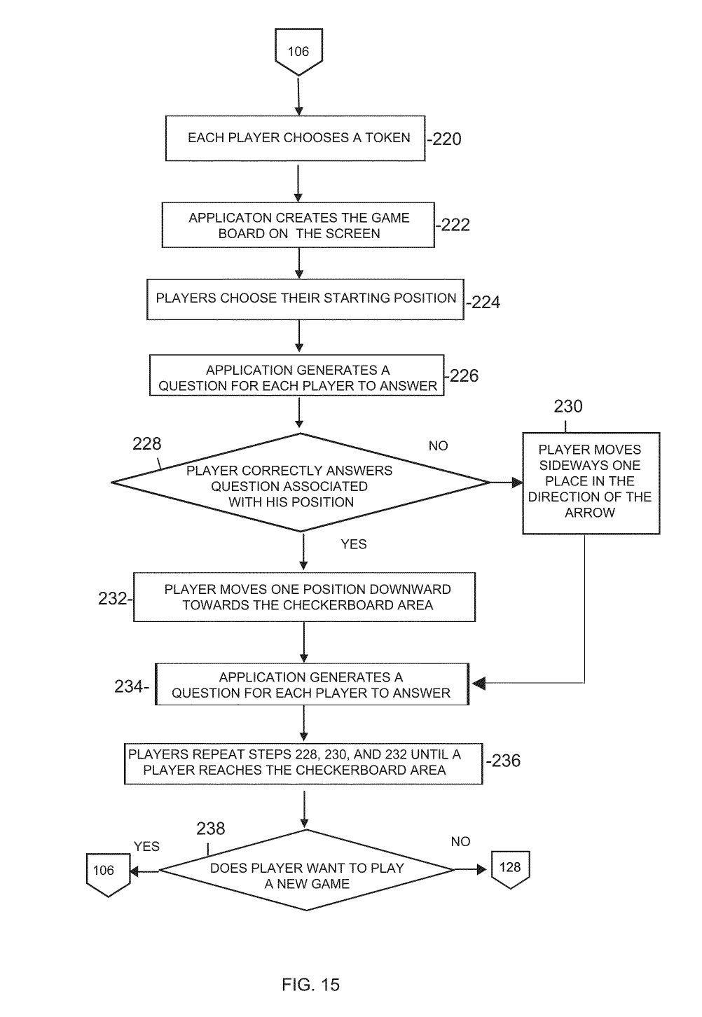

FIG. 15 is a flow chart depicting one way that the Timeline Game application may be configured. Once a player reaches the “Game Menu” at 106, a user is prompted to select a token/game piece at 220. Next, the application may create the game board on the screen of the electronic device utilized by the user playing the Timeline Game at 222. After each player logged onto the game will select their starting position at 224, the application generates a question for each player based on the color of box their token/game piece is positioned on at 226. If the player answer their question correctly—lists each item in the correct order for earliest to latest (or vice versa, from latest in time to earliest in time as requested by the application question)—at 228, then the player moves his token/game piece one position along line 51 at 232. If the player at 228 answers the question incorrectly—list the items in the incorrect order from earliest to latest in time (or vice versa, if requested by the application question), then the player moves his or her token/game piece sideways along line 49 at 230. The application then generates anew question for each player so that the question relates to the subject of the box the player's token/game piece is positioned on at 234. This process repeats from steps 228, 230, and 232 until a player reaches the checkerboard 60 area winning the Timeline Game. Upon completion of a game, the player(s) will be prompted regarding whether he or they desire to play a new game at 238. If a player desires to play a new game, then the player will be prompted to the “Game Menu” 106. If a player does not desire to play another game at 238, the application will begin the close application process at Box 128.

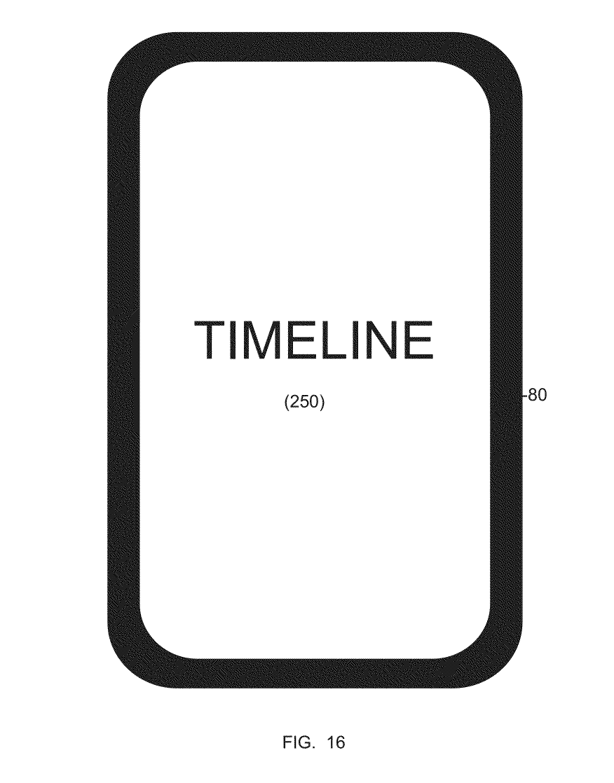

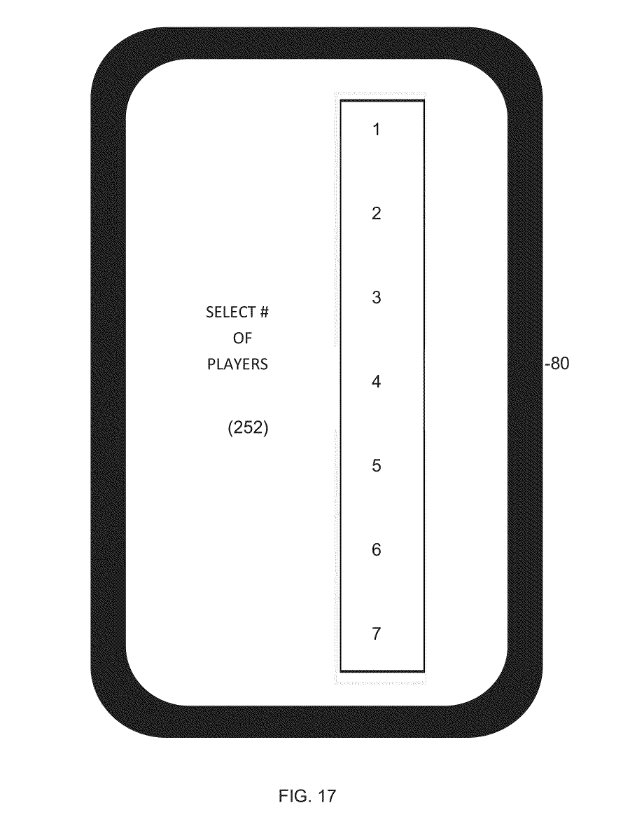

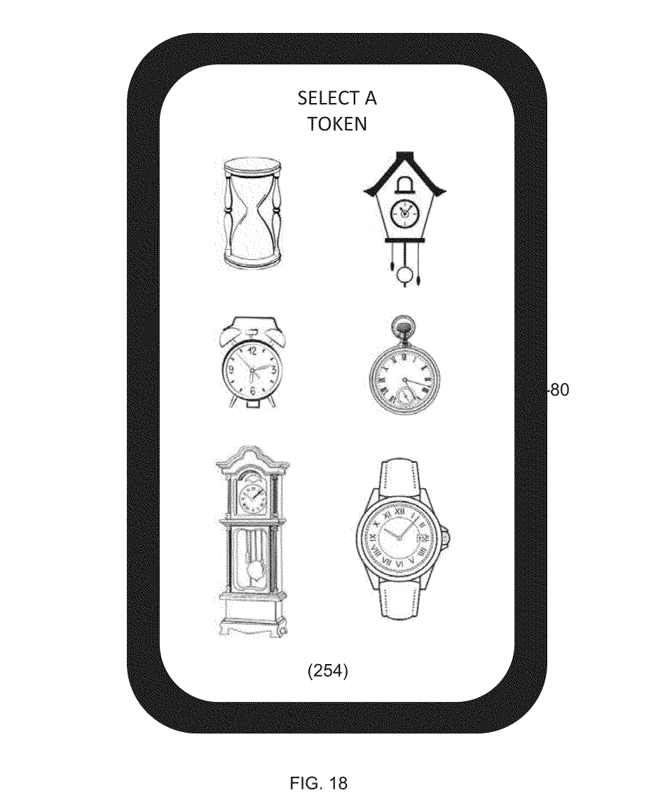

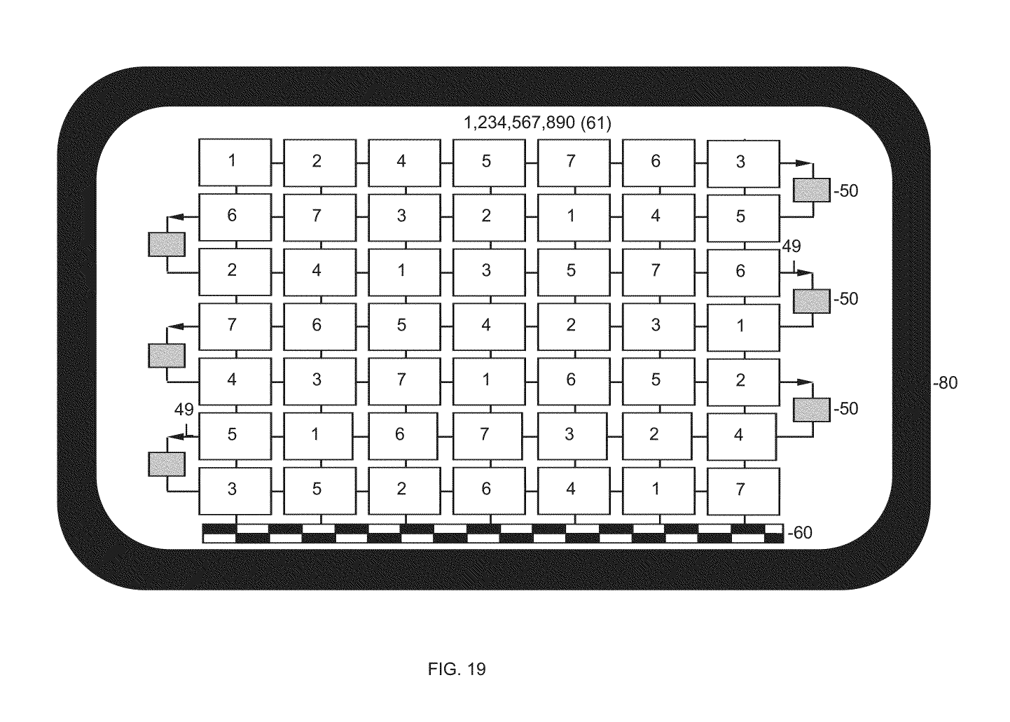

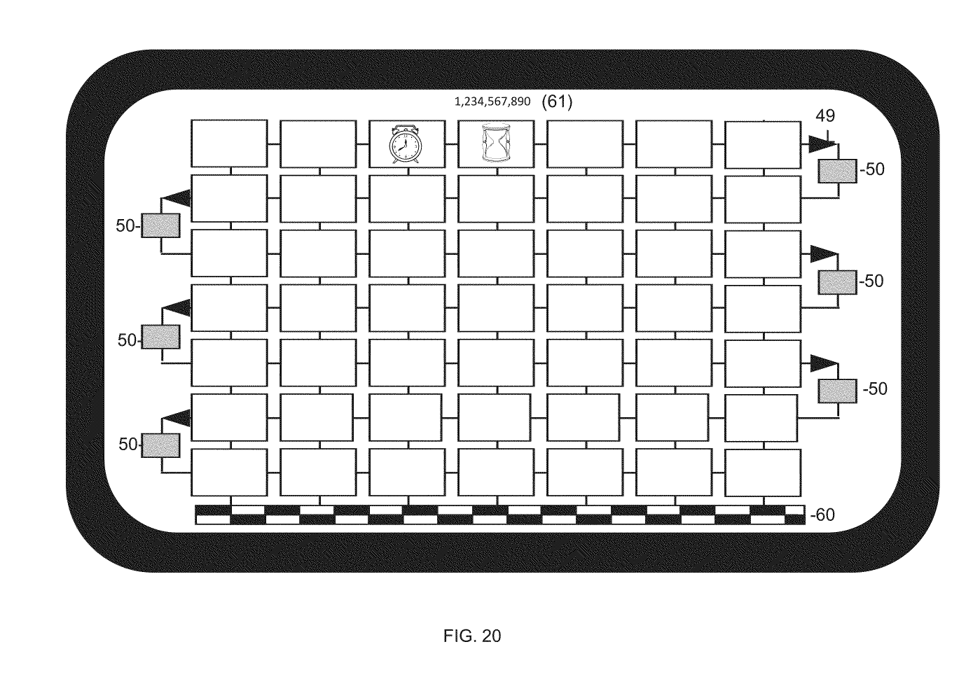

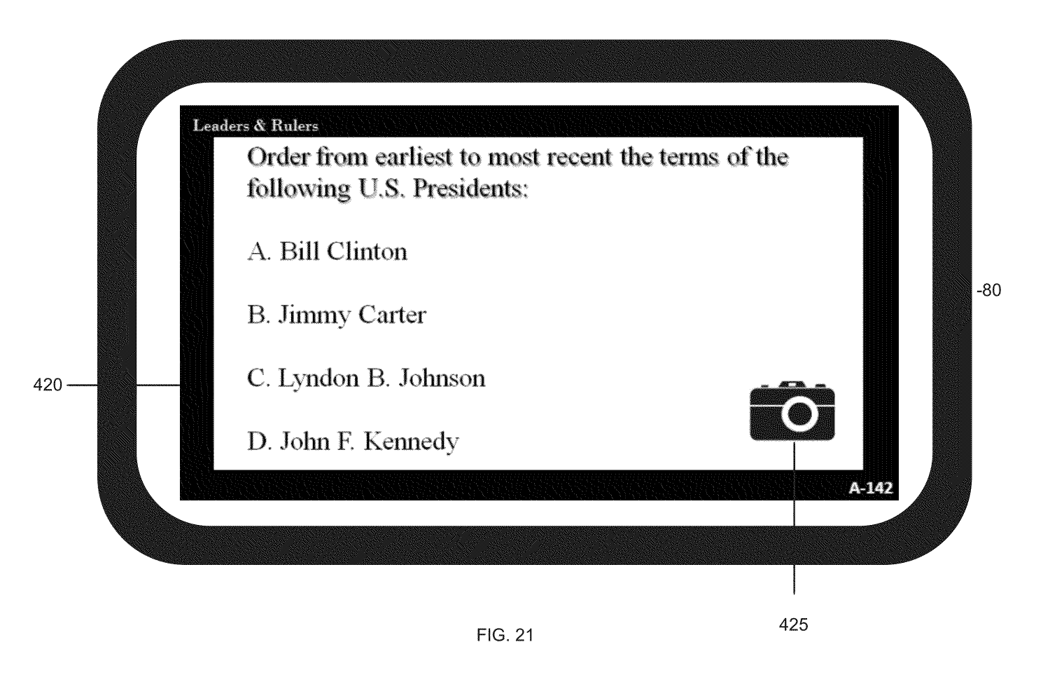

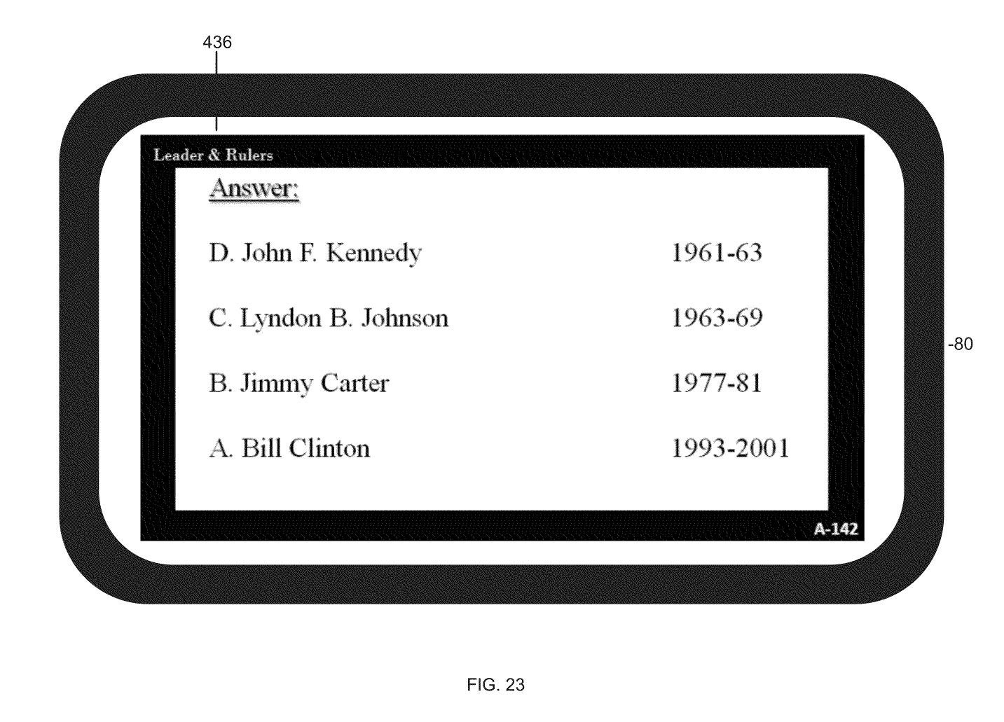

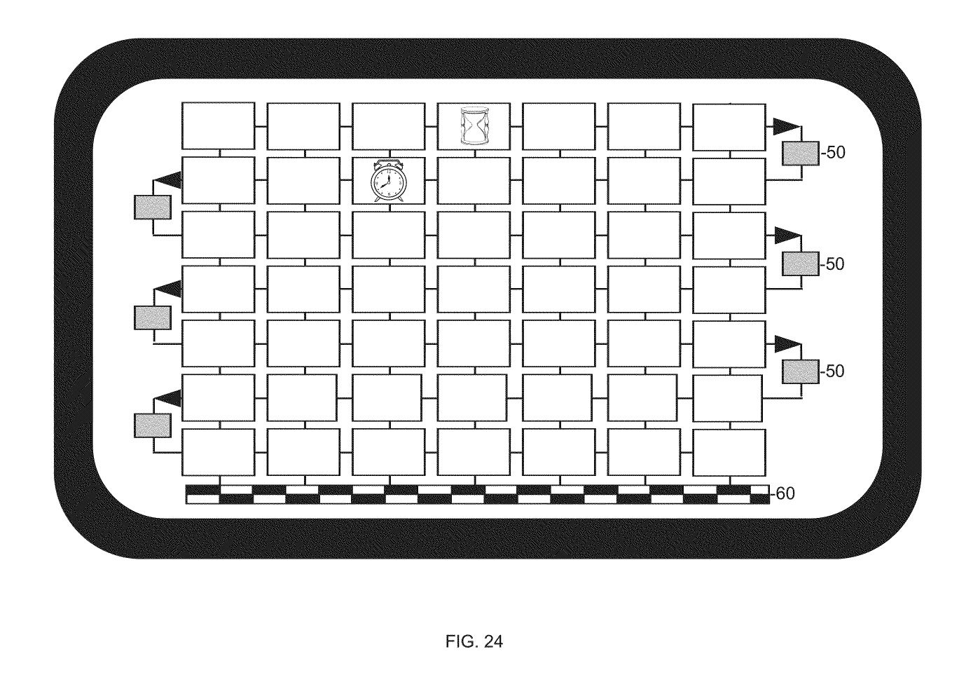

FIG. 16 depicts a screenshot that a user may see when they access the Timeline Game application wherein the screen displays “TIMELINE” 250. FIG. 17 illustrates a screenshot that a user may see on his or her smartphone when they select the number of players 252 for a particular game. FIG. 18 is a screenshot 254 illustrating what a user may see when prompted at 220 (FIG. 15) to select a token/game piece before playing the Timeline Game. FIG. 19 depicts a screenshot that a player may see when the application generates the game board at 222 (FIG. 15). Note that the screenshot may display the number assigned to a particular game 61. The screenshot depicted in FIG. 19 displays game number 1,234,567,890 61. FIG. 20 is a screenshot depicting the selection of starting positions at 224 (FIG. 15). FIG. 21 depicts a screenshot of a sample question 420 relating to leaders and rulers category. When present, the camera symbol 425 allows a player to select to see a picture of the items to be ordered from earliest to occur to latest to occur. FIG. 22 depicts what a player may see when they select the camera symbol 425 pictured on FIG. 21. FIG. 22 illustrates four pictures: 427, 428, 429, and 430 that depict the items listed in A, B, C, and D, respectively. The player may select the actual picture displayed, the number below the picture (431, 432, 433, or 434 which correspond to item A, B, C, and D, respectively), or one of the four boxes 435 located at the bottom of the screenshot. FIG. 23 depicts screenshot 436 which depicts the correct ordering of items at 228 (FIG. 15). FIG. 24 depicts a screenshot of the movement of a player (in this case the windup alarm clock 71) moving along line 51 at 232 (FIG. 15).

I hereby claim:

1. A game comprising:
a game board having a pattern of stations thereon for defining paths of travel to a final station,
playing pieces adapted for placement on the stations, and.
accessory cards assigned to different stations, wherein said accessory cards list four items that a player must place in the correct order in time from earliest to latest to advance along a defined path of travel towards a final station.

2. The game of claim 1 wherein a player moves sideways or backwards and not towards the final station when the four items listed on the accessory card are not placed in the correct order in time from earliest to latest.

3. The game of claim 1 wherein the game board is divided into 49 stations having 7 rows with seven stations per row.

4. The game of claim 1 wherein said playing pieces include tokens shaped in the form of an item relating to measuring time.

5. The game of claim 1 wherein accessory cards assigned to different stations, list four items that a player must place in the correct order in time from latest to earliest to advance along a defined path of travel towards a final station.

6. The game of claim 5 wherein a player moves sideways or backwards and not towards the final station when the four items listed on the accessory card to be ordered in time from latest to earliest are not placed in the correct order.

7. A computer-implemented game comprising:
a computer-generated game board having a pattern of stations thereon for defining paths of travel to a final station,
a computer-generated playing piece adapted for placement on the stations, and.
A computer-generated accessory cards assigned to different stations, wherein said accessory cards list four items that a player must place in the correct order in time from earliest to latest to advance along a defined path of travel toward the final station.

8. The game of claim 7 wherein a player moves sideways or backwards and not towards the final station when the four items on the computer-generated accessory card are not placed in the correct order in time from earliest to latest.

9. The game of claim 7 wherein the computer-generated game board is divided into 49 stations having 7 rows with seven stations per row.

10. The game of claim 7 wherein said computer-generated playing piece includes tokens depicted as an item relating to measuring time.

11. The game of claim 7 wherein computer-generated accessory cards are assigned particular stations, and list four items that a player must place in the correct order in time from latest to earliest to advance along a defined path of travel towards the final station.

12. The game of claim 11 wherein a player moves sideways or backwards and not towards the final station when the four items listed on the computer-generated accessory card are not placed in the correct order in time from latest to earliest.
